(19) United States
(12) Patent Application Publication
(10) Pub. No.: US 2026/0160597 A1
(43) Pub. Date: Jun. 11, 2026

(54) LIGHT COMPONENT DETECTOR AND DETECTING METHOD

(71) Applicant: INDUSTRIAL TECHNOLOGY RESEARCH INSTITUTE, Hsinchu (TW)

(72) Inventors: Cheng-Hsien CHEN, Taoyuan City (TW); Shu-Chun LIAO, Hsinchu County (TW)

(73) Assignee: INDUSTRIAL TECHNOLOGY RESEARCH INSTITUTE, Hsinchu (TW)

(21) Appl. No.: 19/001,869

(22) Filed: Dec. 26, 2024

(30) Foreign Application Priority Data
Dec. 10, 2024 (TW) 113147912

(51) Int. Cl. G01J 3/28

(52) U.S. Cl. CPC G01J 3/28

(57) ABSTRACT

The present disclosure proposes a light component detector and detecting method. The light component detector, for detecting a light source of semiconductor processing equipment, includes: a substrate, at least one detecting element and coated blocks. The at least one detecting element is disposed on the substrate. The coated blocks are disposed on the at least one detecting element and have thicknesses, respectively. The thicknesses correspond to light wavelengths, respectively.

### CROSS-REFERENCE TO RELATED APPLICATIONS

This non-provisional application claims priority under 35 U.S.C. § 119 (a) on patent application No(s). 113147912 filed in Republic of China (ROC) on Dec. 10, 2024, the entire contents of which are hereby incorporated by reference.

### BACKGROUND

### 1. Technical Field

This disclosure relates to a light component detector and detecting method.

### 2. Related Art

Lithography is a technology used to form desired pattern on a target substrate and is widely applied in the manufacturing of integrated circuits (ICs). Specifically, in this application, radiation from a specific light beam can be used to reduce and focus a target circuit pattern onto a wafer through an optical system, thereby transferring the defined pattern onto the target area of the wafer. In recent years, with breakthroughs in related technologies, extreme ultraviolet (EUV) light has begun to be adopted as a light source in lithography. Since EUV light is well-suited for exposing more complex and precise circuit patterns, it has driven further advancements in nanotechnology.

Currently, EUV equipment provides control options that allow users to select an appropriate one of multiple preset light source intensity and wavelengths. Since the composition of deep ultraviolet (DUV) wavelength in the EUV light source increases by 3.6%, the line width tolerance for exposure dose (exposure latitude, EL) decreases by about 1%, and the line width non-uniformity within the exposure area increases by 0.1 nanometers (nm). Therefore, the intensity and wavelength of the EUV light source are critical to the wafer fabrication process.

### SUMMARY

According to one or more embodiment of this disclosure, a light component detector, adapted to detect a light source of semiconductor processing equipment, includes: a substrate, at least one detecting element and a plurality of coated blocks. The at least one detecting element is disposed on the substrate. The plurality of coated blocks are disposed on the at least one detecting element and having a plurality of thicknesses, respectively, and the plurality of thicknesses correspond to a plurality of light wavelengths, respectively.

According to one or more embodiment of this disclosure, a light component detecting method includes: obtaining a plurality of light signals corresponding to the plurality of light wavelengths by the light component detector described above, wherein the plurality of light wavelengths comprise an in-band wavelength and an out-of-band wavelength; obtaining a plurality of optical radiation parameters corresponding to the plurality of thicknesses, respectively, according to the plurality of light signals; and determining light intensity corresponding to the in-band wavelength and light intensity corresponding to the out-of-band wavelength according to the plurality of optical radiation parameters.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1A is a schematic diagram illustrating a light component detector carried by a moving platform of semiconductor processing equipment according to an embodiment of the present disclosure, FIG. 1B is a schematic diagram illustrating a detecting element and coated blocks according to an embodiment of the present disclosure;

FIG. 2 is a schematic diagram of a side view of the light component detector according to an embodiment of the present disclosure;

FIG. 3 is a schematic diagram of a side view of the light component detector according to another embodiment of the present disclosure;

FIG. 4 is a flow chart illustrating a light component detecting method according to an embodiment of the present disclosure;

FIG. 5 is a flow chart illustrating obtaining light intensity of an in-band wavelength and light intensity of an out-of-band wavelength of the light component detecting method according to an embodiment of the present disclosure;

FIG. 6A to FIG. 6D are diagrams of transmittances and photon energy corresponding to different thicknesses according to an embodiment of the present disclosure;

FIG. 7 is a flow chart illustrating obtaining optical radiation parameters of the light component detecting method according to an embodiment of the present disclosure;

FIG. 8 is a schematic diagram illustrating coated blocks according to an embodiment of the present disclosure;

FIG. 9A to FIG. 9D are diagrams of transmittances and photon energy corresponding to different thicknesses according to another embodiment of the present disclosure; and

FIG. 10A is a schematic diagram illustrating light intensity corresponding to FIG. 9A to FIG. 9D, FIG. 10B is a diagram of the light intensity of the in-band wavelength and the light intensity of the out-of-band wavelength corresponding to FIG. 10A.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

According to the technical field of the present disclosure, the following descriptions may use the terms “radiate”, “emit”, “incident”, “illuminate” or “expose” etc. to represent the light emitted by a light source during a photolithography process towards a substrate (for example, a wafer), but the present disclosure is not limited thereto.

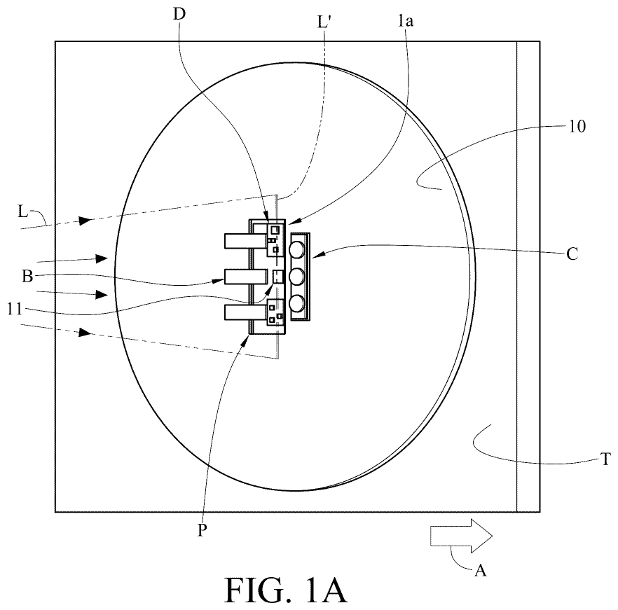

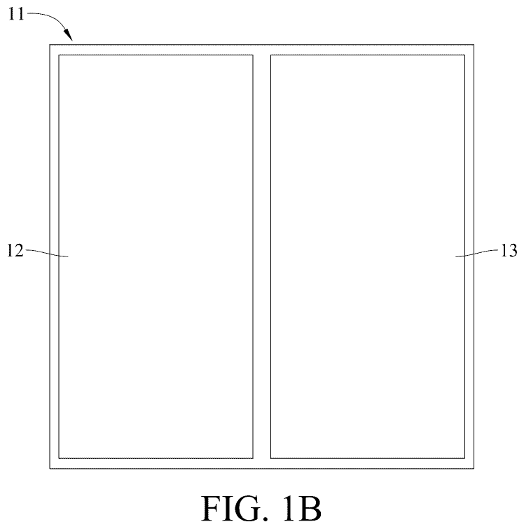

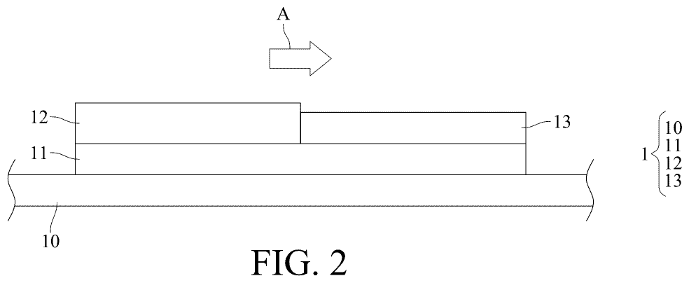

Please refer to FIG. 1A, FIG. 1B and FIG. 2, wherein FIG. 1A is a schematic diagram illustrating a light component detector carried by a moving platform of semiconductor processing equipment according to an embodiment of the present disclosure, FIG. 1B is a schematic diagram illustrating a detecting element and coated blocks according to an embodiment of the present disclosure, and FIG. 2 is a schematic diagram of a side view of the light component detector according to an embodiment of the present disclosure. The light component detector 1 shown in FIG. 1A, FIG. 1B and FIG. 2 is adapted to detect a light source of semiconductor processing equipment. Further, the semiconductor processing equipment may include extreme ultraviolet (EUV) photolithography equipment. The light source may include light radiated by the semiconductor processing equipment towards the wafer. In addition, the light source L shown in FIG. 1 may be the light source configured to radiate or illuminate a substrate 10 during the photolithography process. The light source L may have a wavelength of 365 nm, 248 nm, 193 nm, 157 nm or 13.5 nm.

Please first refer to FIG. 1A and FIG. 1B, the light component detector 1 includes the substrate 10, at least one detecting element 11 and coated blocks 12 and 13. The detecting element 11 is disposed on the substrate 10. Further, the detecting element 11 may be disposed on the inspection platform 1a, and the inspection platform 1a may be located on the substrate 10 and integrated with the substrate 10. The coated blocks 12 and 13 are disposed on the detecting element 11. The inspection platform 1a may be placed on or fixed on a specific area of the substrate 10 in any suitable manner. More specifically, the inspection platform 1a may be placed in an area of the substrate 10 which is predetermined to receive incident light during photolithography process. The substrate 10 may be supported by a carrying platform T of the semiconductor processing equipment. The substrate 10 may serve as a carrier for moving the inspection platform 1a. Thus, when the substrate 10 is moved by the carrying platform T, the substrate 10 and the inspection platform 1a thereon may be delivered into the interior of the semiconductor processing equipment, such that the detecting element 11 of the inspection platform 1a is allowed to timely and accurately inspect, record, or analyze the actual values related to properties of light (e.g., light intensity, wavelength, radiation dose, etc.) during the photolithography process.

The substrate 10 may be, but is not limited to, a silicon wafer, a glass wafer, a thinned wafer, or an etched wafer. The carrying platform T is a means that is movable in the interior of the lithography equipment. The carrying platform T may be, but not limited to, a stepper in the photolithography equipment. The carrying platform T may allow the substrate 10 and the inspection platform 1a thereon to be moved relative to a light source L employed during the photolithography process, but the present disclosure is not limited thereto.

The detecting element 11 is configured to detect a light signal coming from the light source L of the semiconductor processing equipment and at least partially penetrating the coated blocks 12 and 13. The detecting element 11 may be or at least including any suitable electrical element that can convert optical signal to electrical signal, such as a light detector. The coated blocks 12 and 13 may be films made of metal or metal alloy, the metal may include aluminum and/or gold etc. The coated blocks 12 and 13 have thicknesses, respectively, and the thicknesses correspond to light wavelengths of the light component detector 1, respectively. In other words, the coated block 12 and the coated block 13 have different thicknesses. Further, the thickness of the coated block 12 corresponds to one light wavelength, and the thickness of the coated block 13 corresponds to another light wavelength. The detecting element 11 may retain the light signal of the light wavelength corresponding to the thickness of the coated block 12 by the coated block 12 and filter out the light signals of other light wavelengths; and the detecting element 11 may retain the light signal of the light wavelength corresponding to the thickness of the coated block 13 by the coated block 13 and filter out the light signals of other light wavelengths.

Additionally or optionally, the inspection platform 1a may further include a board part P, a controller DC, a charging unit C, and at least one power supply unit B. The board part P may be, but is not limited to, any suitable circuit board. The controller DC, the charging unit C, the power supply unit B, and the detecting element 11 may all disposed on or electrically connected to the board part P. The controller DC may be, but is not limited to, any suitable processor and/or digital signal processing (DSP) controller. The controller DC is suitable for processing digital signal. For example, the controller DC is able to process, calculate, or analyze electrical signal that is converted from the light (also called “incident light”) of the light source L by the detecting element 11. The controller DC may be configured to control the way of how the detecting element 11 responds to or receives the incident light according to associated instruction or setting. The charging unit C is provided to provide electricity to the power supply unit B in a wired or wireless manner. The power supply unit B may be any suitable battery that can store and provide electrical energy for the operation required by the inspection platform 1a. The number of the power supply unit B may be one or more. In addition, optionally, to meet other requirements, such as data transmission, analysis, computing, and recording, the inspection platform 1a may contain memory or any suitable electrical element that can support wired/wireless instruction or data transmission or reading.

During the operation of the semiconductor processing equipment, the light source (e.g., the light source L) of the semiconductor processing equipment emits light towards the predetermined area of the substrate 10 so that the inspection platform 1a and the illuminated area L′ illuminated by the incident light coming from the light source L have a relative movement in direction A. Then or meanwhile, since the moving path of the inspection platform 1a is the same as the moving path of the carrying platform T, the inspection platform 1a may move along the carrying platform T such that the detecting element 11 and the coated blocks 12 and 13 thereon pass through the illuminated area L′ of the light source L, and thus, the detecting element 11 is allowed to measure the actual optical properties of the incident light in real time.

To detect the component of the light radiated by the light source during the operation of the semiconductor processing equipment, the light component detector 1 may be moved at a specific speed along a specific direction (as indicated by arrow A) relative to the illuminated area L′ by, for example, the aforementioned carrying platform T. The size of the illuminated area L′ in the direction A may be way smaller than the size (e.g., length D) of the detecting element 11 in the direction A.

It should be noted that FIG. 1A and FIG. 1B exemplarily illustrate two coated blocks 12 and 13, but the number of the coated blocks may also be more than 2, the present disclosure is not limited thereto. Further, the coated block 12 and the coated block 13 may or may not have a gap therebetween.

The light component detector according to one or more embodiments of the present disclosure may detect the composition of the light emitted by the light source of the semiconductor processing equipment in real time with the coating materials. Further, since the yield of semiconductor largely depends on the light composition of light emitted by the light source in semiconductor processing equipment, the light component detector that may perform detection in real time according to one or more of the above embodiments may further enable real-time adjustments to the recipe of the semiconductor processing equipment, thereby reducing the cost of semiconductor processing.

In an embodiment, as shown in FIG. 1A, FIG. 1B and FIG. 2, the coated blocks 12 and 13 may be arranged along the direction A sequentially. The semiconductor processing equipment may include the carrying platform T for carrying the light component detector 1, and the direction A may be the moving direction of the carrying platform T. Then, after the light component detector 1 leaves the exposed area (e.g. the illuminated area L′) of the semiconductor processing equipment, the light component detector 1 may be put into a storage box to charge the detecting element 11 and/or transmitting the detection result of the detecting element 11 of the light component detector 1 to a working station and/or computer in a wired or wireless way, wherein the working station and/or the computer may include the processing device described below.

In addition, the light wavelength may include an in-band wavelength and an out-of-band wavelength. The in-band wavelength may be 13.5 nm, and the out-of-band wavelength may be wavelengths outside of 13.5 nm, but the present disclosure does not limit the specific values of the in-band wavelength and the out-of-band wavelength.

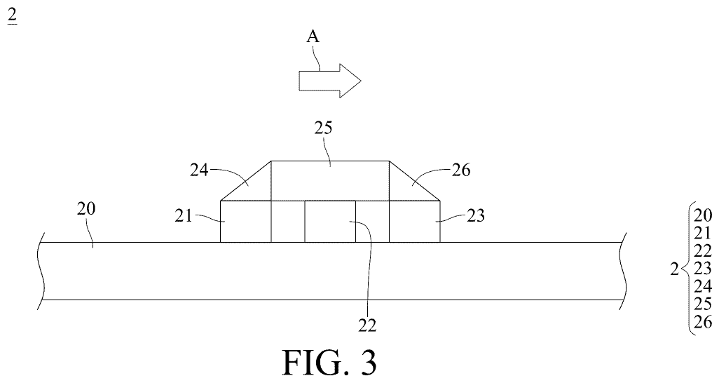

Please refer to FIG. 3, wherein FIG. 3 is a schematic diagram of a side view of the light component detector according to another embodiment of the present disclosure. As shown in FIG. 3, the light component detector 2 includes a substrate 20, detecting elements 21-23 and coated blocks 24-26. The implementation of the substrate 20, the detecting elements 21-23 and the coated blocks 24-26 may be the same as the substrate 10, the detecting element 11 and the coated blocks 12 and 13, respectively, of FIG. 1A, FIG. 1B and FIG. 2.

In the embodiment of FIG. 3, the coated block 24 and the coated block 25 have different thicknesses, and the coated block 25 and the coated block 26 have different thicknesses. The coated block 24 and the coated block 26 may have the same or different thickness. As shown in FIG. 3, the coated block 24 and the coated block 26 may have uneven thicknesses. The coated blocks 24-26 may be disposed on the detecting elements 21-23. Further, the light component detector 2 includes detecting elements 21-23, and the coated block 24 may be disposed on the detecting element 21, the coated block 25 may be disposed on the detecting element 22, and the coated block 26 may be disposed on the detecting element 23. In other words, one coated block may be disposed on one detecting element.

In another embodiment, the light component detector may also include a plurality of detecting elements, and each detecting element may have one coated block disposed thereon or a plurality of coated blocks with different thicknesses disposed thereon.

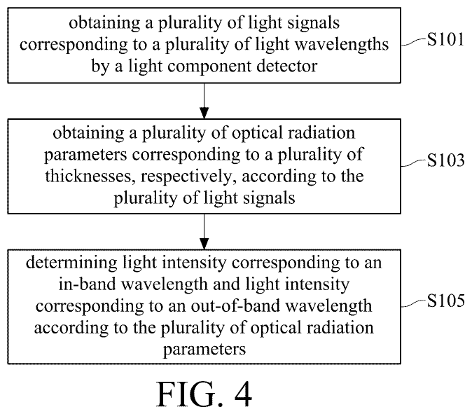

Please refer to FIG. 4, wherein FIG. 4 is a flow chart illustrating a light component detecting method according to an embodiment of the present disclosure. Steps shown in FIG. 4 may be performed by a processing device connected to the detecting element of the light component detector. The processing device may include one or more processors, wherein the processor is, for example, a central processing unit, a graphics processing unit, a microcontroller, a programmable logic controller or any other processor with signal processing function.

As shown in FIG. 4, the light component detecting method includes: step S101: obtaining a plurality of light signals corresponding to the plurality of light wavelengths by the light component detector; step S103: obtaining a plurality of optical radiation parameters corresponding to the plurality of thicknesses, respectively, according to the plurality of light signals; and step S105: determining light intensity corresponding to the in-band wavelength and light intensity corresponding to the out-of-band wavelength according to the plurality of optical radiation parameters.

In step S101, the processing device obtains the light signals corresponding to the light wavelengths from the light component detector of one or more embodiments described above. The light wavelengths cover the in-band wavelength and the out-of-band wavelength. Further, when the semiconductor processing equipment is in operation (e.g., performing photolithography process) and the light source radiates light towards the light component detector, the light component detector may detect the light radiated from the light source in real time to generate the light signal.

In step S103, the processing device obtains the optical radiation parameters corresponding to the thicknesses, respectively, according to the light signals. The optical radiation parameter may include values(s) of at least one of light intensity (e.g. power) and transmittance.

In step S105, the processing device determines the light intensity of the in-band wavelength and the light intensity of the out-of-band wavelength according to the optical radiation parameter. Further, since the light component detector includes the coated blocks, the processing device may determine which coated block that each light signal corresponds to, thereby determining the optical radiation parameter corresponding to the coated block of the in-band wavelength and the optical radiation parameter corresponding to the coated block of the out-of-band wavelength. Therefore, the processing device obtains the light intensity of the in-band wavelength and the light intensity of the out-of-band wavelength.

The light component detecting method according to one or more embodiments of the present disclosure may measure the composition of the light radiated by the light source of the semiconductor processing equipment in real time, thereby adjusting the recipe of the semiconductor processing equipment to reduce the cost of semiconductor processing.

In an embodiment, step S101 may include disposing the light component detector on the carrying platform of the semiconductor processing equipment and making an arrangement direction of the coated blocks to be parallel to the moving direction (i.e. the direction A shown in FIG. 1A, FIG. 1B and FIG. 2) of the carrying platform, and controlling the carrying platform to move along the moving direction for the light component detector to be radiated by the light source of the semiconductor processing equipment, wherein the moving direction intersects a illumination direction of the light source. Further, the illumination direction of the light source of the semiconductor processing equipment may be perpendicular to the surface of the coated block(s), and the carrying platform may be controlled to move to the laminated area of the semiconductor processing equipment along the moving direction.

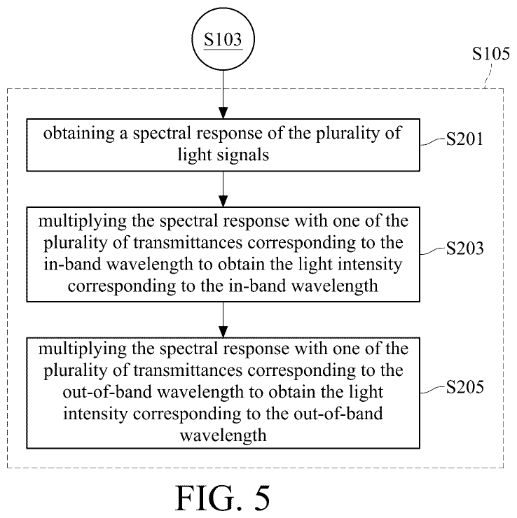

Please refer to FIG. 5, wherein FIG. 5 is a flow chart illustrating obtaining light intensity of an in-band wavelength and light intensity of an out-of-band wavelength of the light component detecting method according to an embodiment of the present disclosure. FIG. 5 may be regarded as a detailed flow chart of step S105 of FIG. 4. In the embodiment of FIG. 5, the optical radiation parameters include a plurality of transmittances corresponding to the plurality of thicknesses, respectively. As shown in FIG. 5, obtaining the light intensity of the in-band wavelength and the light intensity of the out-of-band wavelength includes: step S201: obtaining a spectral response of the plurality of light signals; step S203: multiplying the spectral response with one of the plurality of transmittances corresponding to the in-band wavelength to obtain the light intensity corresponding to the in-band wavelength; and step S205: multiplying the spectral response with one of the plurality of transmittances corresponding to the out-of-band wavelength to obtain the light intensity corresponding to the out-of-band wavelength. The present disclosure does not limit the sequence of performing step S203 and step S205. Step S205 may be performed before step S203 or at the same time as S203. Even though FIG. 5 illustrates step S205 as performed after step S203, FIG. 5 does not intend to limit that the light intensity of the in-band wavelength should be obtained before performing step S205. For example, after obtaining the spectral response, step S203 and step S205 may be performed.

In step S201, the processing device may obtain the spectral response according to the response characteristics of the detecting element on the light signals of different wavelengths. In step S203, the processing device may obtain the transmittance according to a ratio between the intensity of the light signal output by the light source of the semiconductor processing equipment and the intensity of the light signal traveling to the detecting element through the coated block(s) of the in-band wavelength. Specifically, the processing device may obtain the transmittance corresponding to the in-band wavelength according to a ratio between the intensity of the light signal output by the light source of the semiconductor processing equipment and the intensity of the light signal penetrating the coated block(s) of the in-band wavelength and arriving at the detecting element, and the processing device may multiply the transmittance with the spectral response to obtain the light intensity corresponding to the in-band wavelength.

In step S205, similar to step S203, the processing device may obtain the transmittance according to a ratio between the intensity of the light signal output by the light source of the semiconductor processing equipment and the intensity of the light signal traveling to the detecting element through the coated block(s) of the out-of-band wavelength, and the processing device may multiply the transmittance with the spectral response to obtain the light intensity corresponding to the out-of-band wavelength.

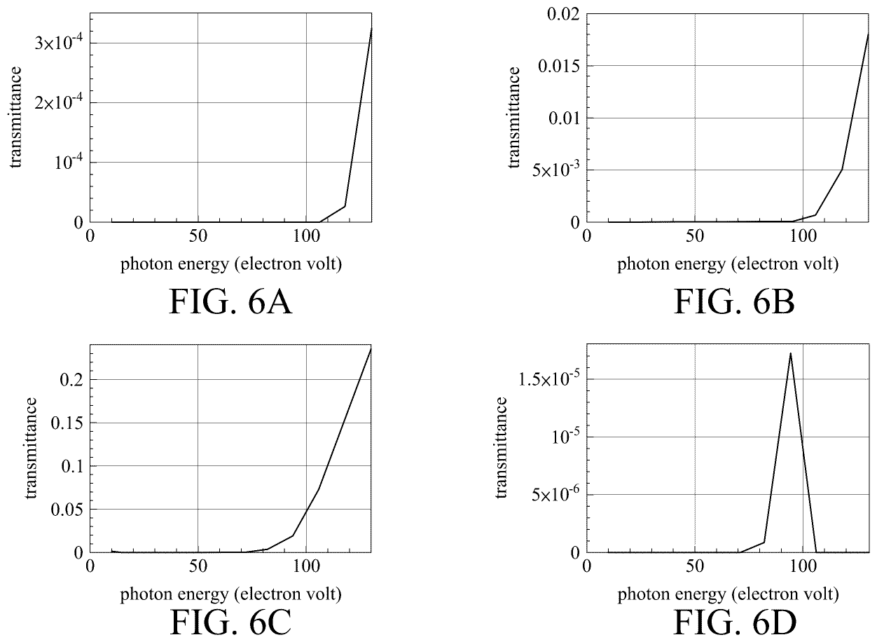

Please refer to FIG. 6A to FIG. 6D, wherein FIG. 6A to FIG. 6D are diagrams of transmittances and photon energy corresponding to different thicknesses according to an embodiment of the present disclosure. In FIG. 6A to FIG. 6D, the horizontal axis represents photon energy (electron volt, eV), and the vertical axis represents transmittance (%). In FIG. 6A to FIG. 6C, the coated block is a film made of gold; and in FIG. 6D, the coated block is a film made of Si3N4. In FIG. 6A, the thickness of the coated block is 0.5 micron; in FIG. 6B, the thickness of the coated block is 0.25 micron; in FIG. 6C, the thickness of the coated block is 0.09 micron; and in FIG. 6D, the thickness of the coated block is 0.2 micron.

Corresponding to the embodiment of FIG. 5, assuming that the coated block corresponding to FIG. 6D is configured to detect the light signal of the in-band wavelength of 13.5 nm, the processing device may multiply the spectral response with the transmittance of FIG. 6D to obtain the light intensity of the in-band wavelength. Further, the processing device may multiply the spectral response with the transmittance of each of FIG. 6A, FIG. 6B and FIG. 6C to obtain the light intensity of the out-of-band wavelengths, thereby analyzing the light component outside of the in-band wavelength.

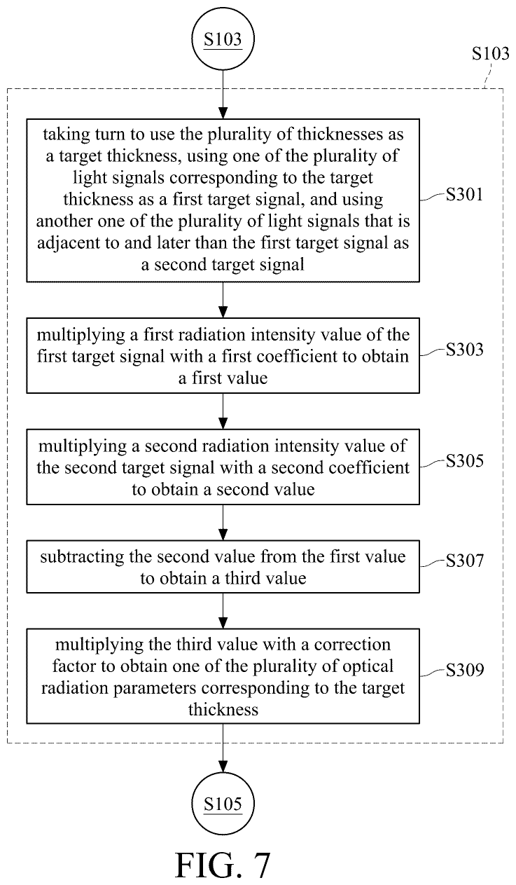

Please refer to FIG. 7, wherein FIG. 7 is a flow chart illustrating obtaining optical radiation parameters of the light component detecting method according to an embodiment of the present disclosure. FIG. 7 may be regarded as a detailed flow chart of step S103 of FIG. 4. As shown in FIG. 7, obtaining optical radiation parameters includes: step S301: taking turn to use the plurality of thicknesses as a target thickness, using one of the plurality of light signals corresponding to the target thickness as a first target signal, and using another one of the plurality of light signals that is adjacent to and later than the first target signal as a second target signal; step S303: multiplying a first radiation intensity value of the first target signal with a first coefficient to obtain a first value; step S305: multiplying a second radiation intensity value of the second target signal with a second coefficient to obtain a second value; step S307: subtracting the second value from the first value to obtain a third value; and step S309: multiplying the third value with a correction factor to obtain one of the plurality of optical radiation parameters corresponding to the target thickness. The present disclosure does not limit the sequence of performing step S303 and step S305. Step S305 may be performed before step S303 or at the same time as step S303. Even though FIG. 7 illustrates step S305 as performed after step S303, FIG. 7 does not intend to limit that the first value should be obtained before performing step S305. For example, after obtaining the first target signal and the second target signal, step S303 and step S305 may be performed.

In step S301, the processing device uses the thickness of each of the coated blocks as the target thickness, uses the light signal corresponding to the target thickness as the first target signal, and uses the light signal following the first target signal as the second target signal. Assuming that the first target signal corresponds to a first coated block among the coated blocks, then the second target signal corresponds to a second coated block adjacent to the first coated block along the moving direction (the direction A shown in FIG. 1A) among the coated blocks. Further, the coated block that is the first one of the coated blocks being radiated by the light source of the semiconductor processing equipment may be regarded as an initial coated block, the first coated block may be one of the coated blocks that is next to the initial coated block along the moving direction, and the second coated block may be one of the coated blocks that is next to the first coated block along the moving direction.

In step S303, the processing device multiplies the first radiation intensity value of the first target signal with the first coefficient to obtain the first value. The first radiation intensity value may be an electron volt value of the first target signal. The first radiation intensity value is radiation intensity obtained by the detecting element when the light source of the semiconductor processing equipment scans through the first coated block with the target thickness. The first coefficient may be a weight coefficient between the first radiation intensity value and an initial radiation intensity value corresponding to an initial thickness among the thicknesses. The first coefficient may be associated with the coating material and the thickness of the first coated block. The initial thickness may be the thickness of the initial coated block.

In step S305, the processing device multiplies the second radiation intensity value of the second target signal with the second coefficient to obtain the second value. The second radiation intensity value may be an electron volt value of the second target signal. The second radiation intensity value is radiation intensity obtained by the detecting element when the light source of the semiconductor processing equipment scans through the second coated block. The second coefficient may be a weight coefficient between the second radiation intensity value and the initial radiation intensity value corresponding to the initial thickness among the thicknesses. The second coefficient may be associated with the coating material and the thickness of the second coated block.

In step S307, the processing device subtracts the second value from the first value to obtain the third value. In step S309, the processing device multiplies the third value with the correction factor to obtain the optical radiation parameter corresponding to the target thickness. The correction factor may be used to correct differences between multiple light component detectors, substrates of different suppliers, detecting elements of different suppliers and different coating materials.

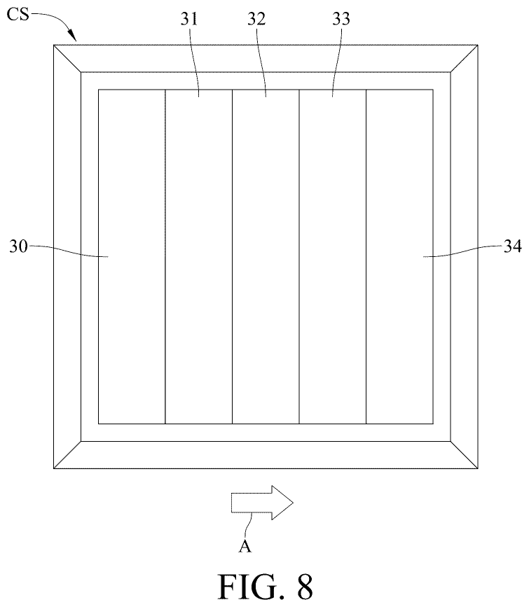

Please refer to FIG. 8, wherein FIG. 8 is a schematic diagram illustrating coated blocks according to an embodiment of the present disclosure. For the convenience of description, FIG. 8 only shows the coated blocks of the light component detector. The inspection platform may include a holder CS, the holder CS may be any suitable means and may be fixed on any required area of the substrate (or the board part P as illustrated above) and is configured to releasably hold the detecting element in position, such that the detecting element may be easily installed or removed using the holder CS. The coated blocks 30-34 disposed in the holder CS may be arranged along the direction A, and the coated blocks 30-34 may have different thicknesses.

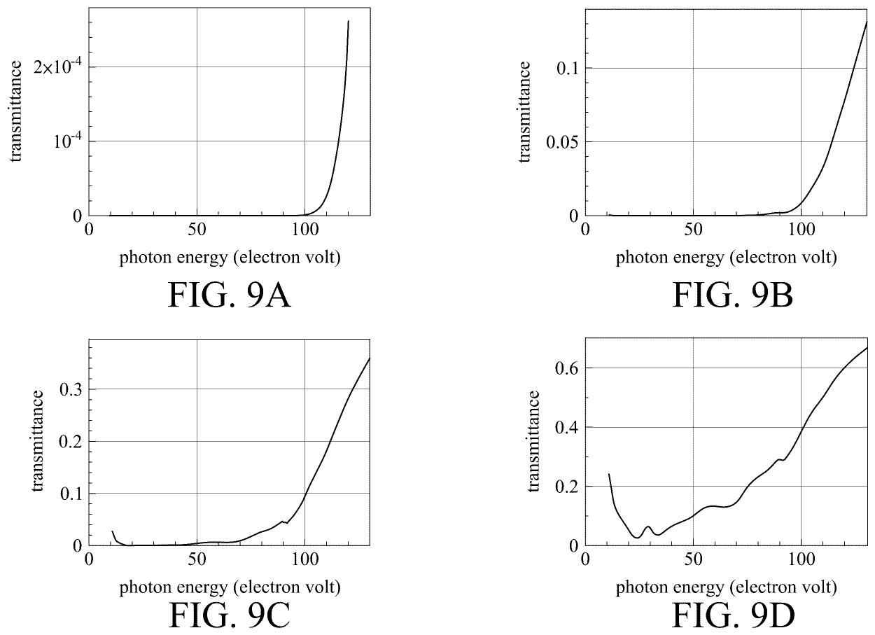

Please refer to FIG. 8 and FIG. 9A to FIG. 9D, wherein FIG. 9A to FIG. 9D are diagrams of transmittances and photon energy corresponding to different thicknesses according to another embodiment of the present disclosure. In FIG. 9A to FIG. 9D, the horizontal axis represents photon energy (electron volt, eV), and the vertical axis represents transmittance (%). The coated blocks 31-34 are films made of gold, and the coated block 30 may be film made of other metal, the present disclosure is not limited thereto. The thickness of the coated block 30 may be nay thickness, or the thickness of the coated block 30 may be 0, that is, the coated block 30 may not have coating material thereon. The thickness of the coated block 31 is 0.5 micron; the thickness of the coated block 32 is 0.1 micron; the thickness of the coated block 33 is 0.05 micron; and the thickness of the coated block 34 is 0.02 micron. Further, as described above, since the coated blocks 30 to 34 may be arranged along the direction A, the processing device may distinguish the radiation intensity of each of the coated blocks corresponding to different thicknesses according to the detection timing of the light component detector. The transmittances and photon energy of the coated blocks 31 to 34 are shown in FIG. 9A to FIG. 9D, respectively.

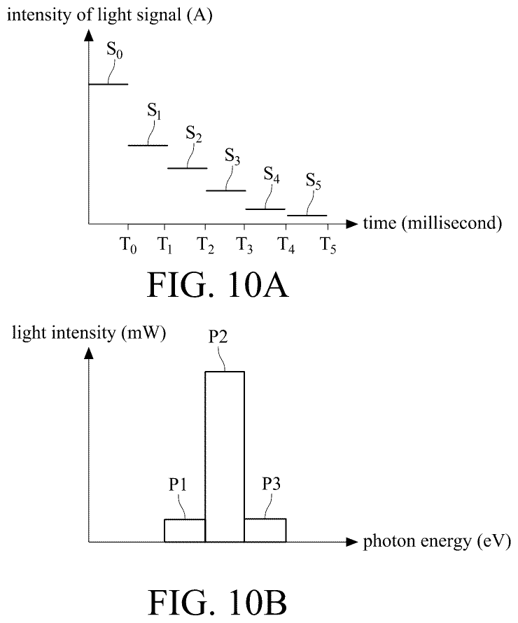

Please refer to FIG. 10A and FIG. 10B, wherein FIG. 10A is a schematic diagram illustrating light intensity corresponding to FIG. 9A to FIG. 9D, and FIG. 10B is a diagram of the light intensity of the in-band wavelength and the light intensity of the out-of-band wavelength corresponding to FIG. 10A. It should be noted that FIG. 10A and FIG. 10B are schematic diagrams illustrated for explaining radiation intensity and light intensity, which are used for examples. In FIG. 10A, the horizontal axis represents time (ms), and the vertical axis represents radiation intensity (i.e. intensity (μA) of light signal); and in FIG. 10B, the horizontal axis represents time (ms), and the vertical axis represents the light intensity (mW). For better understanding, the light signal shown in FIG. 9A may be illustrated as the light signal S₁ generated between the detection time point T₀ and the detection time point T₁ shown in FIG. 10A; the light signal shown in FIG. 9B may be illustrated as the light signal S₂ generated between the detection time point T₁ and the detection time point T₂ shown in FIG. 10A; the light signal shown in FIG. 9C may be illustrated as the light signal S₃ generated between the detection time point T₂ and the detection time point T₃ shown in FIG. 10A; and the light signal shown in FIG. 9D may be illustrated as the light signal S₄ generated between the detection time point T₃ and the detection time point T₄ shown in FIG. 10A. In addition, FIG. 10A may further include the light signal S₀ generated between the time point where the detection is initiated and the detection time point T₀, and the light signal S₅ generated between the detection time point T₄ and the detection time point T₅, wherein the light signal S₀ may correspond to the coated block 30 with no coating material.

Take FIG. 10A as an example, the light signal S₀ is the light signal corresponding to the initial coated block 30. In step S301 of FIG. 7, the light signal S₁ is used as the first target signal, and the light signal S₂ is used as the second target signal; then, the processing device may use the light signal S₂ as the first target signal, and use the light signal S₃ as the second target signal, and so on.

Steps S303, S305, S307 and S309 of FIG. 7 may be implemented with equation (1) to equation (4) below, wherein Sᵢ is the light signal detected by the detecting element when the coated block with the thickness of Hᵢ is scanned by the light source at time point Tᵢ; P_{λi} is the radiation intensity of the light signal detected by the detecting element when the coated block with the thickness of Hᵢ is scanned by the light source at time point Tᵢ; Wᵢ is a weight coefficient between the radiation intensity corresponding to the thickness of Hᵢ and the radiation intensity corresponding to the thickness of H₀; and C₀ to C₃ are correction factors for radiation intensity. Parameter i is an integer, a lower limit of i is 0, and an upper limit of i is the number of the coated blocks subtracted by 1.

$${P}_{λ0} = ( {S}_{0} - {W}_{1} \times {S}_{1} ) \times {C}_{0} \qquad equation ( 1 )$$

$${P}_{λ1} = ( {W}_{1} \times {S}_{1} - {W}_{2} \times {S}_{2} ) \times {C}_{1} \qquad equation ( 2 )$$

$${P}_{λ2} = ( {W}_{2} \times {S}_{2} - {W}_{3} \times {S}_{3} ) \times {C}_{2} \qquad equation ( 3 )$$

$${P}_{λ3} = ( {W}_{3} \times {S}_{3} - {W}_{4} \times {S}_{4} ) \times {C}_{3} \qquad equation ( 4 )$$

$${P}_{λ4} = ( {W}_{4} \times {S}_{4} - {W}_{5} \times {S}_{5} ) \times {C}_{4} \qquad equation ( 5 )$$

Continuing from the example of FIG. 8, the coated block 30 is the initial coated block, the corresponding light signal is S₀, the first target signal corresponding to the coated block 31 is S₁, the second target signal corresponding to the coated block 32 is S₂, the first radiation intensity value is P_{λ1}, the second radiation intensity value is P_{λ2}, the first coefficient is W₁, the second coefficient is W₂, the first value is W₁×S₁, the second value is W₂×S₂, and the correction factor is C₁.

In the embodiment of FIG. 7, determining the light intensity corresponding to the in-band wavelength and the light intensity corresponding to the out-of-band wavelength according to the plurality of optical radiation parameters (step S105 of FIG. 4) may include performing subtraction on every two adjacent optical radiation parameters among the plurality of optical radiation parameters to obtain the light intensity corresponding to the in-band wavelength and the light intensity corresponding to the out-of-band wavelength. Take FIG. 10A and FIG. 10B for example and assume that Sᵢ is the light signal generated by the coated block with the thickness of Hᵢ when the light source scans said coated block at time point Tᵢ, the processing device may subtract the radiation intensity value P_{λ1} from the radiation intensity value P_{λ2} to obtain the light intensity P1 of the out-of-band wavelength, subtract the radiation intensity value P_{λ3} from the radiation intensity value P_{λ3} to obtain the light intensity P2 of the in-band wavelength, and subtract the radiation intensity value P_{λ3} from the radiation intensity value P_{λ4} to obtain the light intensity P3 of the out-of-band wavelength.

The light component detecting method according to one or more embodiments of the present disclosure may be implemented with non-transitory computer readable media. Further, the non-transitory computer readable media may include one or more computer-executable programs, the steps of the light component detecting method may be performed when said one or more computer-executable programs is executed by the processing device.

In view of the above description, the light component detector according to one or more embodiments of the present disclosure may detect the composition of the light emitted by the light source of the semiconductor processing equipment in real time with the coating materials. Further, since the yield of semiconductor largely depends on the light composition of light emitted by the light source in semiconductor processing equipment, the light component detector that may perform detection in real time according to one or more of the above embodiments may further enable real-time adjustments to the recipe of the semiconductor processing equipment, thereby reducing the cost of semiconductor processing. The light component detecting method according to one or more embodiments of the present disclosure may measure the composition of the light radiated by the light source of the semiconductor processing equipment in real time, thereby adjusting the recipe of the semiconductor processing equipment to reduce the cost of semiconductor processing.

What is claimed is:

1. A light component detector, adapted to detect a light source of semiconductor processing equipment, comprising:
a substrate;
at least one detecting element disposed on the substrate; and
a plurality of coated blocks disposed on the at least one detecting element and having a plurality of thicknesses, respectively, and the plurality of thicknesses corresponding to a plurality of light wavelengths, respectively.

2. The light component detector according to claim 1, wherein the plurality of coated blocks are arranged sequentially along a direction.

3. The light component detector according to claim 1, wherein the at least one detecting element comprises a plurality of detecting elements, and the plurality of coated blocks are disposed on the plurality of detecting elements, respectively.

4. The light component detector according to claim 1, wherein the plurality of light wavelengths comprise an in-band wavelength and an out-of-band wavelength.

5. The light component detector according to claim 1, wherein the substrate is a silicon wafer.

6. A light component detecting method, comprising:
obtaining a plurality of light signals corresponding to the plurality of light wavelengths by the light component detector according to claim 1, wherein the plurality of light wavelengths comprise an in-band wavelength and an out-of-band wavelength;
obtaining a plurality of optical radiation parameters corresponding to the plurality of thicknesses, respectively, according to the plurality of light signals; and
determining light intensity corresponding to the in-band wavelength and light intensity corresponding to the out-of-band wavelength according to the plurality of optical radiation parameters.

7. The light component detecting method according to claim 6, wherein obtaining the plurality of light signals corresponding to the plurality of light wavelengths comprises:
disposing the light component detector on a carrying platform of the semiconductor processing equipment, wherein an arrangement direction of the plurality of coated blocks is parallel to a moving direction of the carrying platform, and the moving direction intersects a illumination direction of the light source; and
controlling the carrying platform to move along the moving direction for the light component detector to be illuminated by the light source.

8. The light component detecting method according to claim 6, wherein the plurality of optical radiation parameters comprise a plurality of transmittances corresponding to the plurality of thicknesses, respectively, and determining the light intensity corresponding to the in-band wavelength and the light intensity corresponding to the out-of-band wavelength according to the plurality of optical radiation parameters comprises:
obtaining a spectral response of the plurality of light signals;
multiplying the spectral response with one of the plurality of transmittances corresponding to the in-band wavelength to obtain the light intensity corresponding to the in-band wavelength; and
multiplying the spectral response with one of the plurality of transmittances corresponding to the out-of-band wavelength to obtain the light intensity corresponding to the out-of-band wavelength.

9. The light component detecting method according to claim 6, wherein obtaining the plurality of optical radiation parameters corresponding to the plurality of thicknesses, respectively, according to the plurality of light signals comprises:
taking turn to use the plurality of thicknesses as a target thickness, using one of the plurality of light signals corresponding to the target thickness as a first target signal, and using another one of the plurality of light signals that is adjacent to and later than the first target signal as a second target signal, and performing:
multiplying a first radiation intensity value of the first target signal with a first coefficient to obtain a first value;
multiplying a second radiation intensity value of the second target signal with a second coefficient to obtain a second value;
subtracting the second value from the first value to obtain a third value; and
multiplying the third value with a correction factor to obtain one of the plurality of optical radiation parameters corresponding to the target thickness,
wherein the first coefficient is a weight coefficient between the first radiation intensity value and an initial radiation intensity value corresponding to an initial thickness among the plurality of thicknesses, and the second coefficient is a weight coefficient between the second radiation intensity value and the initial radiation intensity value.

10. The light component detecting method according to claim 9, wherein determining the light intensity corresponding to the in-band wavelength and the light intensity corresponding to the out-of-band wavelength according to the plurality of optical radiation parameters comprises:
performing subtraction on every two adjacent optical radiation parameters among the plurality of optical radiation parameters to obtain the light intensity corresponding to the in-band wavelength and the light intensity corresponding to the out-of-band wavelength.
